(19) United States
(12) Patent Application Publication
(10) Pub. No.: US 2017/0139548 A1
(43) Pub. Date: May 18, 2017

(54) SYSTEMS AND METHODS FOR A ROTATING THREE-DIMENSIONAL MENU

(71) Applicant: MasterCard International Incorporated, Purchase, NY (US)

(72) Inventors: Gerardo A. De Las Heras, O'Fallon, MO (US); Michael Martel Spratt, Maryland Heights, MO (US); Nicole Ara Zavradinos, Brentwood, MO (US); Kimberly Ann Schrey, Wentzville, MO (US); Craig Louis Prior, St. Louis, MO (US); Sandy Bequette, Wildwood, MO (US)

(21) Appl. No.: 14/941,284

(22) Filed: Nov. 13, 2015

(51) Int. Cl. G06F 3/0482; G06F 17/22; G06F 3/0484; G06F 3/0481; G06F 3/0485

(52) U.S. Cl. CPC G06F 3/0482; G06F 3/04815; G06F 3/04817; G06F 3/0485; G06F 3/04845; G06F 17/2235

(57) ABSTRACT

A system for displaying a navigational menu on a webpage is provided. The navigational menu includes a widget that is executed by a processor in communication with a memory. The widget is configured to display an interactive virtual icon. The widget is further configured to receive a user interaction, from the user computing device, with the icon. The widget is also configured to display, in response to the user interaction with the icon, one or more interactive virtual three-dimensional (3-D) objects that rotate around the icon. The widget is still configured rotate the objects around the icon in response to input from the user.

### BACKGROUND OF THE DISCLOSURE

This disclosure relates generally to navigating webpages and applications using a three-dimensional menu, and more specifically to systems and methods that include a widget that causes a display of an interactive icon surrounded by interactive, virtual three-dimensional objects that electronically rotate around the icon, wherein users can navigate to webpages and applications via the objects. Three-dimensionality and depth is virtually simulated by displaying larger objects that appear closer to a user with smaller objects that appear farther from the user.

At least some known systems for displaying links to available applications and webpages are limited to only displaying one or two dimensional links (e.g., a text link or URL link) that are configured to direct a user, when clicked, to a webpage. Many users find that one or two dimensional links are not easily accessible, user friendly or intuitive. Additionally, when numerous links are displayed in the form of known text links, these known text links consume much of the screen and are not convenient for use on smaller displays.

Accordingly, a system is needed that provides a simple intuitive interactive display that includes multiple links that a user can easily interact with to access different online webpages or applications.

### BRIEF DESCRIPTION OF THE DISCLOSURE

In one embodiment, a computer system for displaying an interactive three-dimensional navigational menu on a webpage is provided. The system includes a memory device for storing data and a processor in communication with the memory device. The processor is programmed to execute a widget on a user computing device, wherein the widget is configured to display an interactive virtual icon. The widget is also configured to receive a user interaction, from the user computing device, with the icon. The widget is further configured to display, in response to the user interaction with the icon, one or more interactive virtual three-dimensional (3-D) objects that rotate around the icon. The widget is still further configured to rotate the objects around the icon in response to input from the user.

In another embodiment, a computer-implemented method for displaying an interactive three-dimensional navigational menu on a webpage is provided. The method is implemented by a memory device for storing data and a processor in communication with the memory device. The processor is programmed to execute a widget on a user computing device, wherein the widget is configured to display an interactive virtual icon. The method includes receiving a user interaction, from the user computing device, with the icon. The method further includes displaying, in response to the user interaction with the icon, one or more interactive virtual three-dimensional (3-D) objects that rotate around the icon. The method further includes rotating the objects around the icon in response to input from the user.

In yet another embodiment, one or more computer-readable storage media having computer-executable instructions embodied thereon is provided. When executed by at least one processor, coupled to a memory, the computer-executable instructions cause the processor to display an interactive virtual icon. The computer-executable instructions also cause the processor to receive a user interaction, from the user computing device, with the icon. The computer-executable instructions further cause to display, in response to the user interaction with the icon, one or more interactive virtual three-dimensional (3-D) objects that rotate around the icon. The computer-executable instructions further cause the objects to rotate around the icon in response to input from the user.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

FIG. 1 is a simplified block diagram of an example virtual three-dimensional navigation (VTDN) computing system according to one embodiment disclosed herein.

FIG. 2 is a simplified block diagram of a server system for the example VTDN computing system shown in FIG. 1.

FIG. 3 illustrates one example of a virtual three-dimensional (3-D) navigational menu that is displayed by a widget executing on the user computing device shown in FIG. 1.

FIG. 4 illustrates one example of a webpage displaying the virtual 3-D navigational menu shown in FIG. 3.

FIG. 5 is a flowchart of an example method implemented by the virtual VTDN computing system shown in FIGS. 1 and 2 for executing and displaying the virtual 3-D navigational menu.

### DETAILED DESCRIPTION

The detailed description herein illustrates embodiments of the invention by way of example and not by way of limitation. It is contemplated that the invention has general application to managing computing infrastructures.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present invention are not intended to be interpreted as excluding the existence of additional embodiments that also incorporate the recited features.

The systems and methods described herein relate to navigating webpages and applications, and more specifically to a system that includes a widget configured to display an interactive virtual three-dimensional (3-D) navigational menu, which enables users to more easily navigate to webpages and applications. The system described herein is referred to as a Virtual Three-Dimensional Navigation (VTDN) computing system. The VTDN computing system includes a server device, a widget generating (WG) computing device having a memory and processor, and at least one user computing device, where the server device is in communication with the at least one user computing device. In some embodiments, the WG computing device is also in communication with other computing devices through a network (e.g., internet, local network, payment network, etc.) and is capable of receiving data from those other devices. The server device provides the widget to the user computing device. The widget is configured to display the 3-D navigational menu on the user computing device.

In the example embodiment, the WG computing device provides the widget to the server device, which then provides the widget to the user computing device. The widget is a snippet or section of code configured to display the 3-D navigational menu on a user interface of the user computing device. In an alternative embodiment, the server device transmits the widget to a third party. The third party provides a user with the widget, for example, embedded in a webpage transmitted from the third party to the user.

In one or more embodiments, the server device provides digital assets, such as webpages, websites, computer applications, and other electronic based modes of communication, in which the widget is embedded. When accessed by the user computing device, the server device provides the digital asset, embedded with the widget, to the user computing device. For example, the user computing device may request a webpage to view, which the server device then transmits, along with the embedded widget, to the user computing device.

The user computing device receives and executes the widget, displaying an icon on the user interface of the user computing device. Upon user interaction with the icon, the widget causes a virtual display of one or more three-dimensional objects that form a three-dimensional carousel formation around the icon, wherein at least a first object is visible in front of the carousel and at least a second object is visible in back of the carousel concurrently with the first object. Interaction may include clicking, tapping, or hovering using a mouse arrow or a mouse cursor on the user computing device. Interaction may also include haptic input, including at least tapping on a user display on a touch sensitive panel (e.g., a touch pad or a touch screen). As explain further below, each object is linked to a website or an application determined by the WG computing device, which provides the user with quick navigational links to websites and/or applications, as described below.

The objects that appear closest to the user are larger in size and the objects that appear farthest from the user are smaller in size, simulating depth and three-dimensionality. The widget is configured to rotate the objects in the same direction, either clockwise or counterclockwise, around the icon with the order of the objects retained thereof. In the example embodiment, the widget is further configured to display the objects as rotating around the icon at a horizontal slant such that the objects that appear in front of the icon appear lower than the objects that appear behind the icon, enabling all of the objects to be visible for interaction by the user. The widget is configured to detect directorial input through an input device, such as a mouse or arrow keys, and rotate the objects around the icon in accordance with the direction of the directorial input. On a touch sensitive panel, the widget is configured to rotate that objects in response to detecting haptic input, including at least a swipe gesture across the user display, the swipe gesture including an initial touchdown point and a direction. In still another embodiment, the widget moves the carousel of objects vertically, horizontally, or any variation thereof in response to detecting directorial input or haptic input on the carousel.

The 3-D navigational menu is overlaid on the page as to not disrupt page content. In the example embodiment, the widget is configured to fix the 3-D navigational menu in a location on the screen regardless of whether the webpage is scrolled up or down. In a further embodiment, the 3-D navigational menu can be relocated to any location on the computing device display in response to the widget detecting directorial input through an input device or in response to dragging the 3-D navigational menu using haptic input.

Each object is configured to include a link or a sub-link to an application or a webpage. The embedded links facilitate navigation to webpages and/or applications. In response to detecting interaction with an object using the input device or haptic input, the widget navigates the user to the webpage or the application linked to the object.

The widget is configured to display the icon on the user interface as a descriptive logo, mark, image, picture, text, graph or geometric shape in a variety of sizes, shapes, colors, and designs, or any combinations thereof. In the example embodiment, the icon is a two-dimensional (2-D) logo in appearance. In an alternative embodiment, the icon is three-dimensional (3-D) in appearance. In the example embodiment, the widget is configured to render the icon with a degree of transparency to enable the user to view at least a portion of the object or objects located behind the icon.

The widget is further configured to display each object on the user interface as a descriptive three-dimensional (3-D) logo, mark, image, picture, animation, text, graph or geometric shape in a variety of sizes, shapes, colors, and designs, or any combinations thereof. In the example embodiment, each object is a three-dimensional sphere with a descriptive image on a surface of the sphere. The descriptive image indicates the webpage or the application linked to the object. For example, an object may appear in a sphere shape with an image of a social media service (e.g., a TWITTER® logo) located on a surface of the sphere to indicate that interacting with the object will open the social media service website. The widget, in response to detecting interaction with the object, will launch the social media service website.

In some embodiments, an application linked to an object is implemented through executable instructions embedded directly in the webpage code and/or the widget. In another embodiment, the application is downloaded as a browser plug-in or a browser extension. In a further embodiment, the application is purchased through an application store (e.g., an app store) as a standalone application (e.g., an app) or included as a feature of another application. In some embodiments, one or more applications from a user computing device can be added to the carousel of objects and/or one or more objects can be removed from the carousel of objects. For example, in some embodiments, a user can “drag and drop” a standalone application into the carousel of objects. In other embodiments, the user can download, for example, as a browser plug-in, a browser extension, or from the application store, one or more additional applications for the carousel of objects.

The number of objects rotating around the icon, and the webpage or the application linked to each object, is determined by the WG computing device and pre-programmed into the widget. The WG computing device creates the widget to be executed by the user computing device. In the example embodiment, the websites and/or applications pre-programmed into the widget are based upon predefined websites and/or applications stored in the memory.

In an alternative embodiment, the applications and/or websites associated with the objects are individualized to a user computing device or a user thereof and are determined based upon device data. The WG computing device determines a plurality of websites and/or applications to include in the 3-D navigational menu based on the data gathered by the server device and device-specific data receive by the server device from the user computing device. Device data may include location of the user computing device, the type of the user computing device (e.g., tablet, laptop, smartphone), the brand of the user computing device, usage patterns from user interaction with the objects, recent searches on the user computing device, favorites, applications, and user “cookie data”. Usage patterns from the user interaction with the objects may include the objects that the user interacts with most often. Recent searches may include searches recently performed on the user computing device. Favorites may include digital assets most often frequented by the user computing device. Favorites may also include webpage, webpages or digital assets that the user of the user computing device has tagged as a “favorite.” Applications may include the currently downloaded applications and those that have been previously downloaded but are no longer active on the user computing device. The “cookie data” may include data gathered from the user's cookies. For example, the user computing device may have stored thereon cookies related to the user's previous search history, user preferences, previous geographical locations of the user, digital assets the user frequents, and the user's previously purchased products. In one embodiment, the server device gathers the device data from the user computing device to maintain in the memory. The WG computing device executes instructions that determine webpages and/or applications to provide to the user computing device within the 3-D navigational menu via objects. The processor creates a widget to be executed by the user computing device, wherein the widget is configured to display objects linked to websites and/or applications based upon the device data. For example, the objects may consist of links to webpages that the user tagged as “favorites” on the user computing device.

In other embodiments, other data from other networks can be used to determine the applications and/or webpages that populate the objects rendered on a user cardholder device display. For example, the widget may be configured such that transaction history between merchants and a user cardholder determines the applications and/or webpages that populate the objects rendered on a user cardholder device display. The server device is configured to receive transaction data for a user cardholder from a payment network and store said data in the memory. The transaction information comprises data relating to merchant identification/name, merchant locations, and purchases made. Based upon the transactions data, the WG computing device determines the webpages and/or the applications to display, via objects, on the user cardholder computing device, and creates the corresponding widget with the webpages and/or the applications. For example, if a user cardholder frequently transacted with a particular vendor, an object linking to the vendor's website may appear in the plurality of objects.

In the example embodiments, any information transmitted and/or stored on the VTDN computing system does not include any personally identifiable information (PII), but rather includes analyzed, anonymized, and/or aggregated data that does not specifically identify a user or a user computing device. In other implementations, where the VTDN computing system may transmit and/or store PII, any PII is encrypted to prevent access to the PII by remote systems and devices. Moreover, in any implementations in which PII may be collected, transmitted, and/or stored, the consumer from which the PII may be collected is provided an opportunity to agree to or deny collection of such data.

In the example embodiment, the WG computing device transmits the widget to the server device. Upon request, the server device transmits the widget to a user computing device. This may include transmitting a requested digital asset, such as a website, embedded with the widget to the user computing device. When the user computing device receives the digital asset, it receives the widget as well. Displaying the digital asset causes execution of the widget by the user computing device such that the icon is displayed. Interaction with the icon starts the process of displaying objects to the user and ultimately results in the user being navigated to a website or application. The server device may also transmit the widget a third party.

In another embodiment, the widget is configured to detect user interaction with a first object causing display of a second tier of objects that rotate around the first object, and can include a second interaction with a second object of the second tier causing display of a third tier of objects that rotate around the second object. In one embodiment, the user may “go back” or “step up” a tier using a return function embedded in at least one object (e.g., a “back arrow” embedded in the object or in an object of a previous tier). Each object in the second and third tier may display a website or an application associated with a website or an application in the first tier. Upon selection of an object from the second or third tier, the embedded link will facilitate navigation of the user to a website or an application associated with the selected object, for example, a second webpage. The second webpage holds content relating to the website or the application in the first tier. For example, the object in the first tier is a first webpage on a website, and the object in the second tier is a second webpage on the same website. This allows the user to have access to content displayed within a wide range of digital assets without having to spend time searching each individual digital asset.

In still another embodiment, the widget is configured to undisplay all objects from the user computing device in response to detecting a second interaction with the icon. For example, a first interaction with an icon causes the objects to be displayed rotating around the icon and a second interaction with the icon undisplays the objects.

A technical effect of the systems and processes described herein include at least one of (a) providing quick navigational links to websites and applications to provide quick navigation across multiple websites and applications; (b) enabling a user to quickly and easily locate and select, based on appearance, the appropriate object associated with the desired application or webpage that the user wishes to access; (c) and conserving screen real-estate.

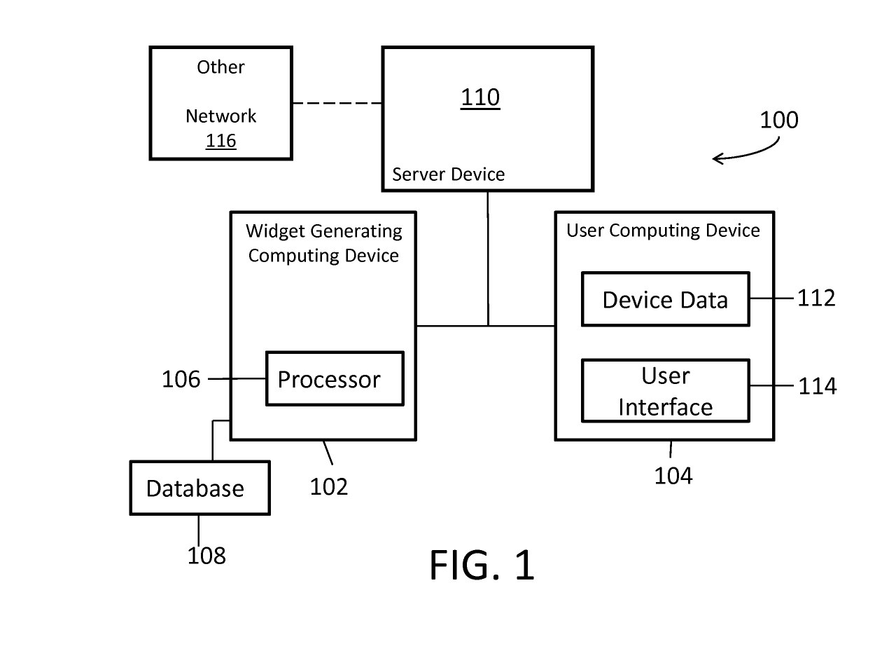

FIG. 1 is a simplified block diagram of an example Three-Dimensional Navigation (VTDN) computing system 100 including a user computing device 104, a widget generating (WG) computing device 102, and a server device 110. User computing device 104 sends a request to server device 110 for widget (not shown) or digital asset (not shown). Server device 110 allows for communication between a processor 106 and a database 108 as well as processor 106 and user computing device 104. Using VTDN 100 system, user computing device 104 communicates directly or indirectly with WG computing device 102. For example, user computing device 104 may send a request to view a webpage (or other digital asset) directly to WG computing device 102. WG computing device 102 may return the webpage, embedded with a widget, to user computing device 104. Alternatively or additionally, user computing device 104 may transmit the request to view the webpage to server device 110. Server device 110 may then transmit the requested digital asset, along with a widget that is embedded within the code of the requested digital asset, to user computing device 104. The user computing device 104 display the digital asset and executes the associated widget for display to the user. In some other embodiments, WG computing device 102 and/or server device 110 transmit the widget without a digital asset.

The WG computing device 102 includes the processor 106, which may include one or more processing units (e.g., in a multi-core configuration). The processor 106 executes instructions. In the example embodiment, the executable instructions include instructions for determining a plurality of websites and/or applications to include in the 3-D navigational menu and generating, transmitting and/or embedding the widget. In some embodiments, the processor 106 is further configured to transmit the digital asset with the embedded widget. In some embodiments, the executable instructions are stored in a memory. In the example embodiment, the memory is a database 108. The database 108 is any device allowing information such as executable instructions and/or other data to be stored and retrieved. Database 108 may include one or more computer-readable media. In one embodiment, the database 108 is stored on WG computing device 102. In any alternative embodiment, the database 108 is stored remotely from the WG computing device 102 and may be non-centralized.

The user computing device 104 includes a user interface 114. The user interface 114 enables the user computing device 104 to present information to and receive interaction from a user. The user interface 114 may any component capable of conveying information to user. In some embodiments, the user interface 114 may include an input device for receiving input from user. The user interface 114 may also include an output device for displaying content such as digital assets to the user. Input device may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device and input device.

In one embodiment, the user computing device 102 may be a computer including a web browser, such that server device 110 and/or WG computing device 102 are accessible to user computing device 104 using the Internet. The user computing device 104 is interconnected to the Internet through many interfaces including a network, such as a local area network (LAN) and/or a wide area network (WAN), dial-in connections, cable modems, wireless-connections, and special high-speed ISDN lines. The user computing device 104 may be any device capable of interconnecting to the Internet including a mobile computing device, such as a notebook computer, a web-based phone, a personal digital assistant (PDA), or other web-connectable equipment.

In one embodiment, device data 112 describing the user computing device 104 is sent to the server device 110 when the user computing device 104 requests a digital asset for display on user computing device 104. The device data 112 describes the user computing device 104 and the type of activity on the user computing device 104. The device data 112 may include the type of the user computing device 104, the brand of the user computing device 104, the cellular network of the user computing device 104, the current location of the user computing device 104, and favorite sites visited by a user of the user computing device 104. The processor 106 of the WG computing device 102 uses the device data 112 to determine probable websites and applications the user may have interest in viewing.

In another embodiment, other data (e.g., browser history or transaction data) is transmitted to server device 110 from other network 116. The widget is configured such that the other data determines the applications and/or webpages that populate the objects rendered on a user device display. Server device 110 is configured to directly receive the other data for a user from other network 116. Based upon the other data, WG computing device 102 determines the webpages and/or the applications to display, via objects, on user cardholder computing device 104, and creates the corresponding widget with the webpages and/or the applications. For example, cardholder transaction data (e.g., merchant names, purchase information, etc.) is transmitted to server device 110 from other network 116 and the widget is configured such that transaction history between merchants and a user cardholder determines the applications and/or webpages that populate the objects rendered on a user cardholder device display. In some embodiments, other network 116 transmits the data directly to WG computing device 102.

Other data and/or device data 112 may be stored in the memory 204, storage device 208, and/or database 108, and retrieved by the processor 106 when the processor 106 is determining the plurality of websites and applications to include in the 3-D navigational menu.

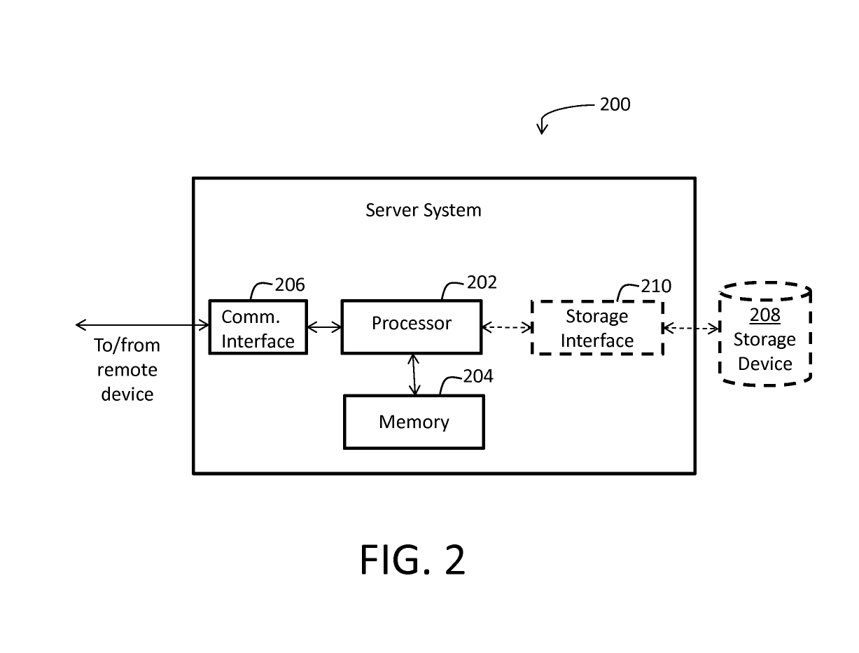

FIG. 2 illustrates an example configuration of a server system 200, such as server device 110 and/or WG computing device 102 (both shown in FIG. 1). The server system 200 includes a processor 202 for executing instructions. Instructions may be stored in a memory 204. The processor 202 may include one or more processing units (e.g., in a multi-core configuration). The processor 202 is operatively coupled to a communication interface 206 such that server system 200 is capable of communicating with a remote device such as user computing device 104 (shown in FIG. 1) or another server system 200.

Processor 202 may also be operatively coupled to a storage device 208. Storage device 208 is any computer-operated hardware suitable for storing and/or retrieving data. In some embodiments, storage device 208 is integrated in server system 200. For example, server system 200 may include one or more hard disk drives as storage device 208. In other embodiments, storage device 208 is external to server system 200 and may be accessed by a plurality of server system 200. For example, storage device 208 may include multiple storage units such as hard disks or solid state disks in a redundant array of inexpensive disks (RAID) configuration. Storage device 208 may include a storage area network (SAN) and/or a network attached storage (NAS) system. In some embodiments, processor 202 is operatively coupled to storage device 208 via a storage interface 210. Storage interface 210 is any component capable of providing processor 202 with access to storage device 208. Storage interface 210 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 202 with access to storage device 208.

Memory area 204 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

In one embodiment, server 110 serves webpages to client devices over a network. Webpages may have differing content, and each may be defined in any current or future developed format including, without limitation, HyperText Markup Language (HTML), eXtensible HTML (XHTML), Wireless Application Protocol (WAP), eXtensible Markup Language (XML), etc. Server 110 serves the webpage (not shown), wherein the widget is embedded in the webpage. When the widget is executed within the webpage on a user computing device, the widget is configured to display an interactive virtual icon, detect user interaction with the icon and respond by displaying one or more interactive virtual three-dimensional (3-D) objects that rotate around the icon. The widget, which is defined herein as a portable chunk of code that can be installed and executed within a webpage by a user without additional compilation, may be implemented, for example, with Dynamic HTML (DHTML), JavaScript, Asynchronous JavaScript and XML (AJAX), and/or Adobe Flash, etc.

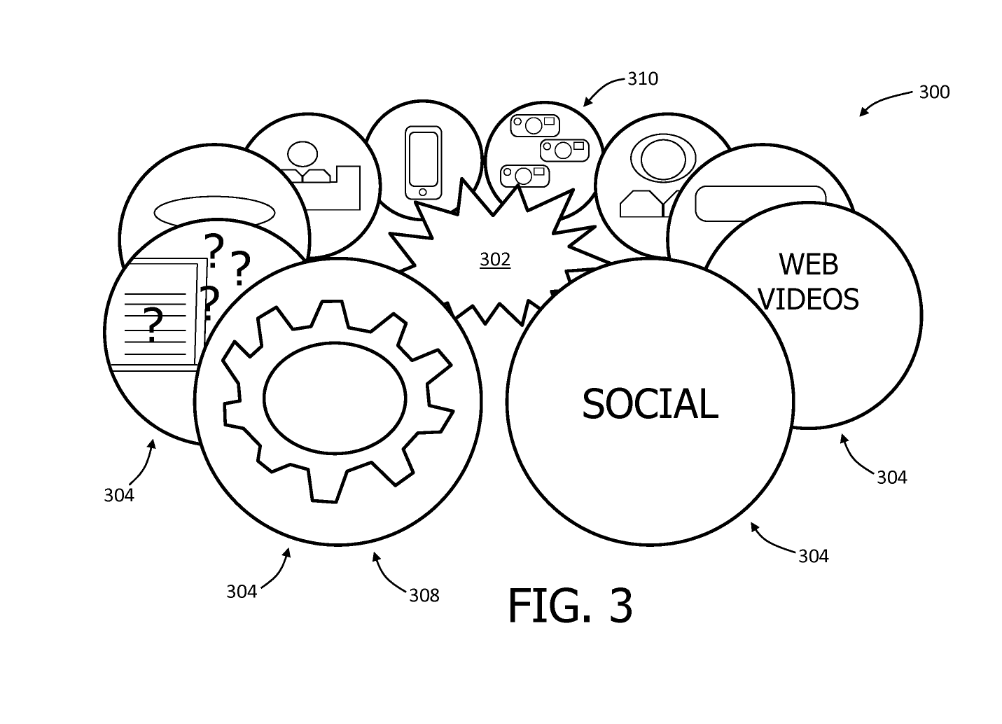

FIG. 3 is an example of a 3-D navigational menu 300 wherein interactive icon 302 is surrounded by one or more three-dimensional objects 304 rotating around icon 302 in a carousel formation. Depth and three-dimensionality is simulated, where at least first object 308 is visible in the front of icon 302 and at least second object 310 is visible in the back of icon 302 concurrently with first object 308, and first object 308 that appears closest to the user is larger in size and second object 310 that appears farthest from the user is smaller in size. This three-dimensional representation is maintained even while objects 304 rotate around icon 302. In the example embodiment, widget is further configured to display objects 304 as rotating around icon 302 at a horizontal slant such that objects appearing in front of icon 302 appear lower than objects appearing behind icon 302, enabling all objects to be visible for interaction by the user.

Upon executing the widget, user computing device 104 causes icon 302 to appear on user interface 114. In response to the widget detecting interaction with the icon 302, one or more three-dimensional objects 304 rotate around icon 302 in a carousel formation. Object 304 has an appearance that indicates an application or a webpage linked to object 304, which includes an embedded link or sub-link to the associated webpage or the application. When the widget detects that there was an interaction between an input device such as a mouse or arrow keys and object 304, the widget navigates the user to the webpage or the application linked to object 304. In another embodiment (not shown), the widget detect an interaction with an object in response to the object being tapped on a touch pad of a mobile device display.

In addition, widget rotates Objects 304 around icon 302 in response to detecting directorial input through the input device. Rotation can occur in a clockwise and/or counter-clockwise direction in response to detecting directorial input through an input device on user computing device 104. In one embodiment, rotation occurs using an arrow cursor and the mouse (not shown) on user computing device 104. On a user computing device with a touch sensitive panel (e.g., a touch pad or a touch screen), rotation occurs using haptic input, including at least a swipe gesture across the user display, the swipe gesture including an initial touchdown point and a direction.

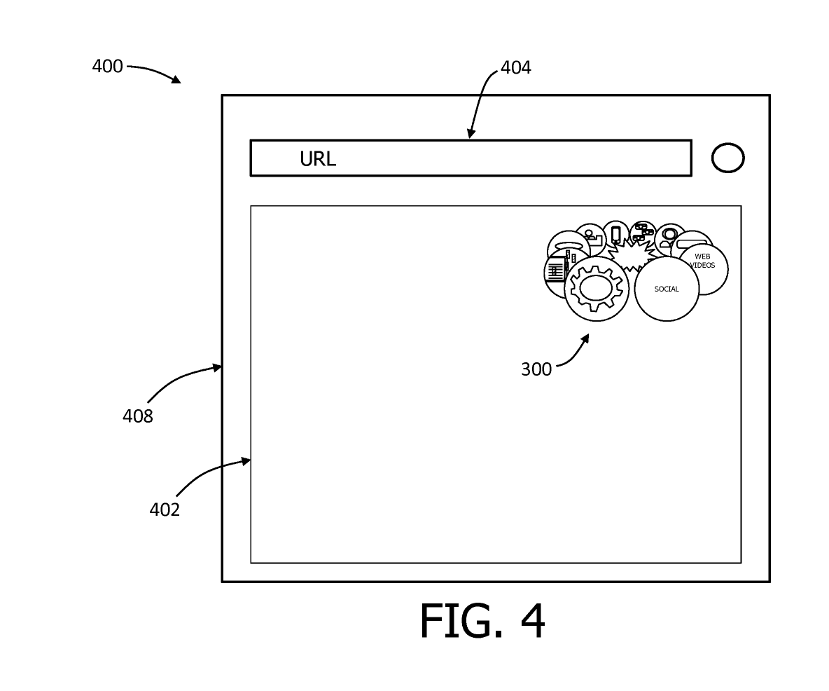

FIG. 4 is an exemplary browser window 400 containing an executed widget on a user interface of a user computing device. In the depicted example, browser window 400 presents an exemplary webpage 402 with an executed widget displaying 3-D navigational menu 300 in the upper right hand corner. URL 404 of webpage, which is presented in the address bar, defines a context for the user. In the depicted example, browser 408 connects to server 110 utilizing a protocol (e.g., HTTP).

Webpage 402 may be maintained by the server device 110 (shown in FIG. 1) or may be maintained by a third party, such as a vendor (e.g., a particular business or company). In some embodiments, the vendor is a company that is selling or marketing itself or its products or services. The vendor maintains digital assets 200 to distribute content or data related to the products or services or to the vendor itself. In some embodiments, the website 202 may be owned by the vendor. In other embodiments, the website 202 may be owned by a third party.

The widget is further configured to detect a user interaction with icon 302 and display, in response to the user interaction with icon 302, one or more virtual three-dimensional (3-D) objects 304 that rotate around icon 302, wherein each object includes a link or sub-link to an application or webpage. The widget is still further configured to detect a user interaction with an object and, in response to the user interaction with the object, navigate the user to an application or webpage linked to the object. In one embodiment, where a webpage is linked to the object, the navigation takes place in the same web browser window by redirecting the user to the website linked to the object. In another embodiment, the navigation takes place by opening a new web browser window containing the webpage linked to the object. In still another embodiment, where an application is linked to the object, the navigation takes place by opening the application.

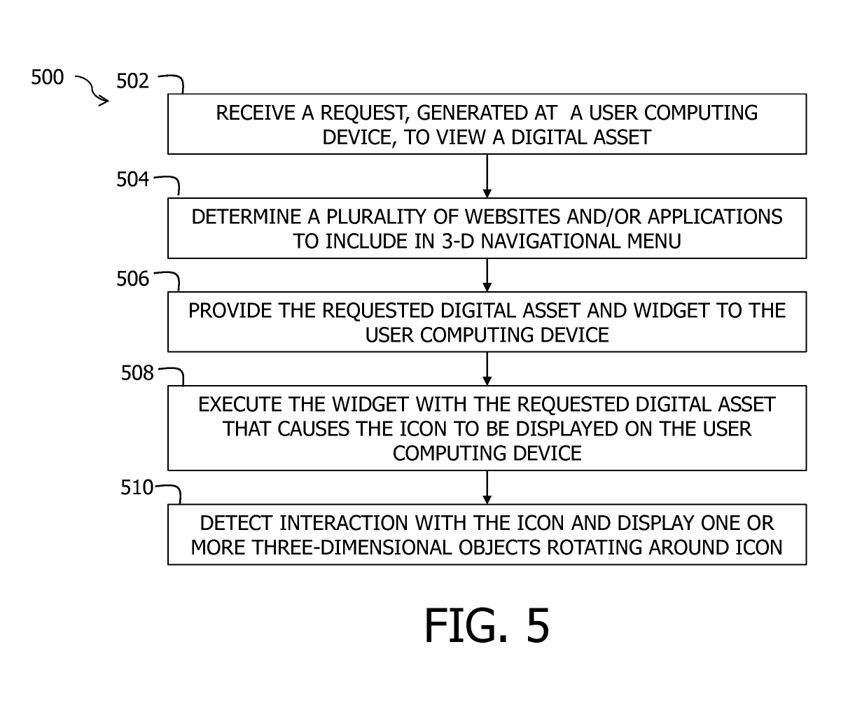

FIG. 5 is a flowchart illustrating an example method 500 implemented by the VTDN computing system 100 shown in FIG. 1 for executing the widget on a webpage, interacting with an icon, and displaying objects. The method begins when a user enters a page load request for a webpage into a browser of a user computing device, for example, by entering a desired Uniform Resource Locator (URL) or IP address into the browser, by selecting a link in a webpage, or by selecting a search result presented by browser. In response to the page load request of the user, the browser issues a corresponding page load request (e.g., an HTTP GET) requesting a copy of the webpage from the server device via a network. The server device receives 502 the page load request, and in response, the GW computing device determines 504 the websites and/or applications to link to the objects in the 3-D navigational menu and creates the widget. The server device provides 506 the webpage to the browser on the user computing device via the network, wherein the widget is embedded in the webpage.

In response to a receipt of the widget by the browser, the browser executes 508 the widget to display an icon within the webpage. In response to detecting 510 a user interaction with the icon, the widget is configured to display one or more three-dimensional objects rotating around the icon, wherein each object includes a link or sub-link to an application or a webpage. The widget is configured to render each object with an appearance indicating the application or the webpage to which each object links. For example, an object that links to a social media application (e.g., Twitter, Facebook, etc.) may be a three-dimensional sphere with an image of the social media provider logo on the surface of the sphere. In response to detecting a user interaction with a particular object, the widget navigates the user to the application or webpage linked to the object.

Various modifications to the disclosed exemplary embodiments can be made. While one or more embodiments have been described, it will be understood by those skilled in the art that various changes in form and detail may be made therein without departing from the spirit and scope of the invention. For example, although various computer system(s) executing program code that directs innovative operations have been described, it should be understood that such operations may be directed by a program product for use with a data processing system. The program product includes program code defining the operations and a data processing system readable storage medium that provides a physical medium to store, carry or encode the program code. It will be appreciated that a wide variety of media, which include, without limitation, non-rewritable storage media (e.g., CD-ROM or DVD-ROM) and rewritable storage media (e.g., a floppy diskette, hard disk drive, DVD, flash memory, etc.), can be employed. It should be understood, therefore, that such data processing system readable storage media, when carrying or storing program code that direct some or all of the described operations, represent alternative embodiments.

In addition, it should be appreciated that although an exemplary network environment has been described herein, various embodiments may employ communication via any of a variety of networks, including without limitation, IP, Ethernet, wireless, and/or cellular, etc. Further, it should be appreciated that the term “browser” as utilized herein is not limited to a conventional browser executing on a personal computer systems (e.g., Internet Explorer or the like), but instead includes smart phone browser applications and any other application that is capable of rendering a webpage.

As used herein, the term “non-transitory computer-readable media” is intended to be representative of any tangible, computer-based device implemented in any method or technology for short-term and long-term storage of information, such as computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the embodiments, including the best mode, and also to enable any person skilled in the art to practice the disclosure, including making and using any devices or systems and performing any incorporated methods. The patentable scope of the embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for displaying a navigational menu on a webpage, said system implemented using a processor in communication with a memory, said system comprising:
a widget, when executed on a user computing device, configured to
display an interactive virtual icon;
receive a user interaction, from the user computing device, with the icon;
display, in response to the user interaction with the icon, one or more interactive virtual three-dimensional (3-D) objects that rotate around the icon, wherein each object includes a link or sub-link to an application or webpage;
receive a user interaction, from the user computing device, with an object; and
navigate a user to an application or webpage linked to the object.

2. A system in accordance with claim 1, wherein the widget is further configured to display the icon and/or the objects as a three-dimensional (3-D) logo, mark, image, picture, text, graph or geometric shape.

3. A system in accordance with claim 1, wherein the widget is further configured to display a text, an image, or animation on the surface of the icon or on the surface of one or more of the objects.

4. A system in accordance with claim 1, wherein the widget is further configured to rotate the objects around the icon in response to detecting directorial input through an input device.

5. A system in accordance with claim 1, wherein the widget is further configured to:
fix the icon and objects in a fixed location on the screen regardless whether the webpage is scrolled; and
enable the user to relocate the icon and objects to any location on the screen.

6. A system in accordance with claim 1, wherein the widget is further configured to receive user interaction with a first object causing display of a second tier of objects that rotate around the first object.

7. The system in accordance with claim 1, wherein the widget is further configured to display the first object that appears in the foreground as having a first size, and display the second object that appears in the background as having a second size, wherein the second size is less than the first size.

8. A computer-implemented method for displaying a navigational menu on a webpage, said method implemented using a processor in communication with a memory, said method comprising the steps of:
displaying an interactive virtual icon;
receiving a user interaction, from the user computing device, with the icon;
displaying, in response to the user interaction with the icon, one or more interactive virtual three-dimensional (3-D) objects that rotate around the icon, wherein each object includes a link or sub-link to an application or webpage;
receiving a user interaction, from the user computing device, with an object; and
navigating a user to an application or webpage linked to the object.

9. The method in accordance with claim 8, wherein said method further comprising displaying the icon and the objects as a three-dimensional (3-D) logo, mark, image, picture, text, graph or geometric shape.

10. The method in accordance with claim 8, wherein said method further comprising displaying a text, an image, or an animation on the surface of one or more of the objects.

11. The method in accordance with claim 8, wherein said method further comprising rotating the objects around the icon in response to detecting directorial input through an input device.

12. The method in accordance with claim 8, wherein said method further comprising:
fixing the icon and objects in a fixed location on the screen independent of scrolling of the webpage; and
enabling the user to relocate the icon and objects to any location on the screen.

13. The method in accordance with claim 8, wherein said method further comprising receiving user interaction with a first object causing display of a second tier of objects that rotate around the first object.

14. The method in accordance with claim 8, wherein said method further comprising displaying the first object that appears in the foreground as having a first size, and displaying the second object that appears in the background as having a second size, wherein the second size is less than the first size.

15. A non-transitory computer readable medium that includes computer executable instructions for displaying a navigational menu on a webpage, wherein when executed by a user computing device with a processor in communication with a memory, the computer executable instructions cause the user computing device to:
display an interactive virtual icon;
display, in response to the user interaction with the icon, one or more interactive virtual three-dimensional (3-D) objects that rotate around the icon, wherein each object includes a link or sub-link to an application or webpage; and
enable a user to navigate to an application or webpage by interacting with an object.

16. A non-transitory computer readable medium in accordance with claim 15, wherein the computer executable instructions display the icon and/or the objects as a three-dimensional (3-D) logo, mark, image, picture, text, graph or geometric shape.

17. A non-transitory computer readable medium in accordance with claim 15, wherein the computer executable instructions cause the computing device to display a text, an image, or animation on the surface of the icon or on the surface of one or more of the objects.

18. A non-transitory computer readable medium in accordance with claim 15, further configured to rotate the objects around the icon in response to detecting directorial input through an input device.

19. A non-transitory computer readable medium in accordance with claim 15, further configured to fix the icon and objects in a fixed location on the screen regardless if the webpage is scrolled, and enable the user to relocate the icon and objects to any location on the screen.

20. A non-transitory computer readable medium in accordance with claim 15, further configured to receive user interaction with a first object causing display of a second tier of objects that rotate around the first object.

21. A non-transitory computer readable medium in accordance with claim 15, further configured to display the first object that appears in the foreground as having a first size, and display the second object that appears in the background as having a second size, wherein the second size is less than the first size.
